(19) United States
(12) Patent Application Publication
(10) Pub. No.: US 2025/0113764 A1
(43) Pub. Date: Apr. 10, 2025

(54) PNEUMATIC VACUUM SYSTEM FOR AN AGRICULTURAL IMPLEMENT

(71) Applicant: CNH Industrial Brasil Ltda., Nova Lima (BR)

(72) Inventors: Maycon Andrade Mendes, Curitiba (BR); Gustavo Thadeu Szczypior, Curitiba (BR); Leandro Gaweleta, Araucaria (BR)

(21) Appl. No.: 18/901,994

(22) Filed: Sep. 30, 2024

(30) Foreign Application Priority Data
Oct. 4, 2023 (BR) 10 2023 020543 7

(51) Int. Cl. A01C 7/08; A01C 7/10

(52) U.S. Cl. CPC A01C 7/082; A01C 7/102

(57) ABSTRACT

A pneumatic vacuum system for an agricultural implement includes multiple pneumatic lines configured to receive an airflow from an air source. The pneumatic vacuum system also includes multiple pneumatic vacuum devices, and each pneumatic vacuum device is fluidly coupled to a respective pneumatic line. Furthermore, each pneumatic vacuum device is configured to receive the airflow and to establish a respective vacuum based on the airflow. In addition, each pneumatic vacuum device is configured to be fluidly coupled to a respective vacuum agricultural product meter of the agricultural implement to provide the respective vacuum to the respective vacuum agricultural product meter.

### BACKGROUND

The present disclosure relates to a pneumatic vacuum system for an agricultural implement.

Generally, planting implements (e.g., planters) are towed behind a tractor or other work vehicle. Planting implements typically include multiple row units distributed across a width of the planting implement. Each row unit is configured to deposit agricultural product (e.g., seeds) at a desired depth beneath the soil surface of a field, thereby establishing rows of planted agricultural product. For example, each row unit typically includes a ground engaging tool or opener that forms a trench for agricultural product (e.g., seed) deposition into the soil. An agricultural product conveying system (e.g., agricultural product tube or powered agricultural product conveyor) is configured to deposit the agricultural product into the trench. The opener/agricultural product conveying system may be followed by closing discs that move displaced soil back into the trench and/or a packer wheel that packs the soil on top of the deposited agricultural product.

In certain planting implements, each row unit includes a vacuum agricultural product meter configured to control a flow rate of the agricultural product (e.g., seed) to the agricultural product conveying system, thereby establishing a desired distribution of the agricultural product throughout the field. To establish a vacuum within each vacuum agricultural product meter, the agricultural implement includes a vacuum pump, and the vacuum pump is fluidly coupled to the vacuum agricultural product meters via vacuum hoses (e.g., via a network of vacuum hoses). The vacuum pump may be driven by a hydraulic motor, thereby providing the vacuum to each vacuum agricultural product meter. Unfortunately, the vacuum pump may generate substantial noise, and the hydraulic motor may consume substantial hydraulic power to drive the vacuum pump. In addition, the acquisition expense of the vacuum hoses (e.g., the network of vacuum hoses) may significantly increase the cost of the planting implement.

### BRIEF DESCRIPTION

In certain embodiments, a pneumatic vacuum system for an agricultural implement includes multiple pneumatic lines configured to receive an airflow from an air source. The pneumatic vacuum system also includes multiple pneumatic vacuum devices, and each pneumatic vacuum device is fluidly coupled to a respective pneumatic line. Furthermore, each pneumatic vacuum device is configured to receive the airflow and to establish a respective vacuum based on the airflow. In addition, each pneumatic vacuum device is configured to be fluidly coupled to a respective vacuum agricultural product meter of the agricultural implement to provide the respective vacuum to the respective vacuum agricultural product meter.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural implement having multiple row units distributed across a width of the agricultural implement;

FIG. 2 is a side view of an embodiment of a row unit that may be employed on the agricultural implement of FIG. 1;

FIG. 3 is a top view of an embodiment of a pneumatic vacuum system that may be employed within the agricultural implement of FIG. 1; and

FIG. 4 is a schematic view of an embodiment of a pneumatic vacuum device that may be employed within the pneumatic vacuum system of FIG. 3.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

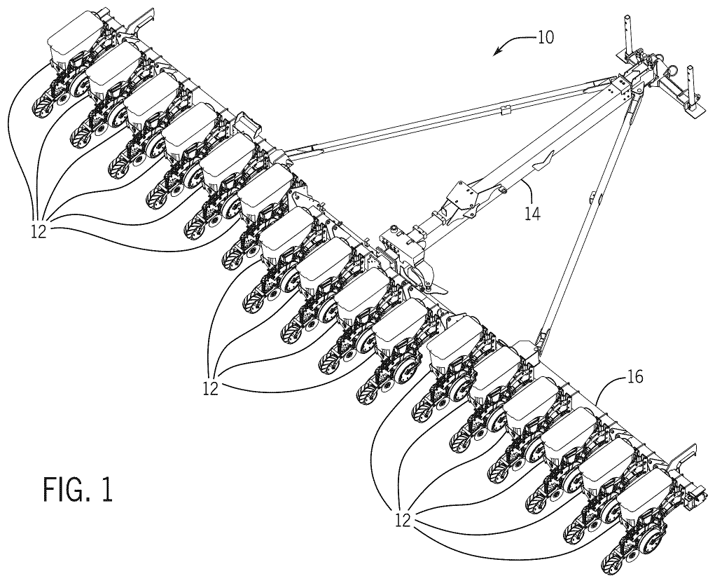

FIG. 1 is a perspective view of an embodiment of an agricultural implement 10 (e.g., planting implement, planter) having multiple row units 12 distributed across a width of the agricultural implement 10. The agricultural implement 10 is configured to be towed through a field behind a work vehicle, such as a tractor. As illustrated, the agricultural implement 10 includes a tongue assembly 14, which includes a hitch configured to couple the agricultural implement 10 to an appropriate tractor hitch (e.g., via a ball, clevis, or other coupling). The tongue assembly 14 is coupled to a tool bar 16 that supports multiple row units 12. Each row unit 12 may include one or more opener discs configured to form a trench within soil of a field. The row unit 12 may also include an agricultural product conveying system (e.g., agricultural product tube or powered agricultural product conveyer) configured to deposit agricultural product (e.g., seed) into the trench. In addition, the row unit 12 may include closing disc(s) and/or a packer wheel positioned behind the agricultural product conveying system. The closing disc(s) are configured to move displaced soil back into the trench, and the packer wheel is configured to pack soil on top of the deposited agricultural product.

As discussed in detail below, each row unit 12 of the agricultural implement 10 includes a vacuum agricultural product meter and a storage compartment (e.g., hopper, mini-hopper, etc.). In certain embodiments, the storage compartment (e.g., hopper) stores a sufficient amount of agricultural product to complete a desired planting operation. Furthermore, in certain embodiments, the storage compartment (e.g., mini-hopper) is configured to receive agricultural product (e.g., continuously, periodically, on-demand, etc.) from a central storage compartment of the agricultural implement during the planting operation. The vacuum agricultural product meter is configured to control a flow rate of the agricultural product (e.g., seed, fertilizer, other agricultural product, etc.) to the agricultural product conveying system, thereby controlling the flow rate of the agricultural product into the trench. As a result, a desired distribution of the agricultural product throughout the field (e.g., a desired seed spacing along a respective seed row) may be established.

In certain embodiments, the agricultural implement 10 includes a pneumatic vacuum system configured to provide a vacuum to each vacuum agricultural product meter. As discussed in detail below, the pneumatic vacuum system includes multiple pneumatic lines configured to receive an airflow from an air source (e.g., fan, blower, etc.). The pneumatic vacuum system also includes multiple pneumatic vacuum devices (e.g., ejectors). Each pneumatic vacuum device is fluidly coupled to a respective pneumatic line, and each pneumatic vacuum device is configured to receive the airflow and to establish a respective vacuum based on the airflow. Furthermore, each pneumatic vacuum device is configured to be fluidly coupled to a respective vacuum agricultural product meter to provide the respective vacuum to the respective vacuum agricultural product meter. Because the vacuum for each vacuum agricultural product meter is provided by the pneumatic vacuum system based on the airflow output by the air source, a vacuum pump is obviated. Accordingly, the noise generated by the agricultural implement may be reduced (e.g., because the air source may be quieter than a vacuum pump). Furthermore, the air source may utilize less energy to establish the vacuum within each vacuum agricultural product meter than the vacuum pump, thereby increasing the efficiency of the agricultural implement. In addition, because the vacuum for each vacuum agricultural product meter is established by a respective pneumatic vacuum device, the respective pneumatic vacuum device may be positioned proximate to the vacuum agricultural product meter, thereby reducing the length of vacuum hoses connecting the pneumatic vacuum devices to the vacuum agricultural product meters (e.g., as compared to vacuum hoses extending between a vacuum pump and the vacuum agricultural product meters) or obviating the vacuum hoses (e.g., in embodiments in which each pneumatic vacuum device is directly fluidly coupled to the respective vacuum agricultural product meter). As a result, the cost of the agricultural implement may be reduced (e.g., because the acquisition expense of the pneumatic lines per unit length may be significantly less than the acquisition expense of the vacuum hoses per unit length).

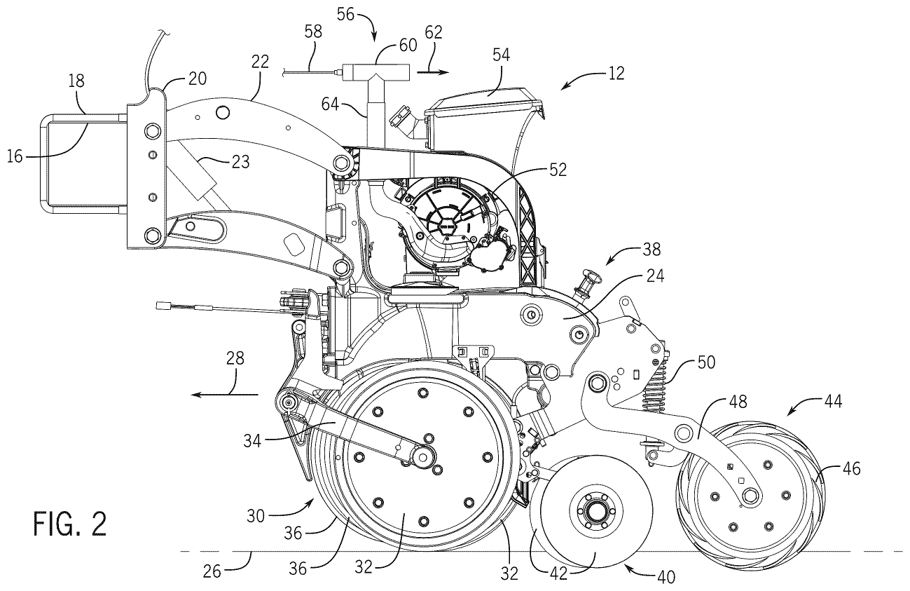

FIG. 2 is a side view of an embodiment of a row unit 12 (e.g., agricultural row unit) that may be employed on the agricultural implement of FIG. 1. The row unit 12 includes a mount 18 configured to secure the row unit 12 to the tool bar 16 of the agricultural implement. In the illustrated embodiment, the mount 18 includes a U-bolt that secures a bracket 20 of the row unit 12 to the tool bar 16. However, in alternative embodiments, the mount may include another suitable device that couples the row unit to the tool bar. A linkage assembly 22 extends from the bracket 20 to a frame 24 of the row unit 12. The linkage assembly 22 is configured to enable vertical movement of the frame 24 relative to the tool bar 16 in response to variations in a soil surface 26. In the illustrated embodiment, an actuator 23 (e.g., hydraulic actuator, pneumatic actuator, electromechanical actuator, etc.) is configured to urge the frame 24 toward the soil surface 26. While the illustrated linkage assembly 22 is a parallel linkage assembly (e.g., a four-bar linkage assembly), in other embodiments, another suitable linkage assembly may extend between the bracket and the frame.

The row unit 12 is configured to deposit agricultural product (e.g., seed, fertilizer, etc.) at a target depth beneath the soil surface 26 as the row unit 12 traverses a field along a direction of travel 28. The row unit 12 includes an opener assembly 30 that forms a trench in the soil for agricultural product deposition into the soil. In the illustrated embodiment, the opener assembly 30 includes gauge wheels 32, arms 34 that pivotally couple the gauge wheels 32 to the frame 24, and opener discs 36. The opener discs 36 are configured to excavate a trench into the soil, and the gauge wheels 32 are configured to control a penetration depth of the opener discs 36 into the soil. In the illustrated embodiment, the row unit 12 includes a depth control system 38 configured to control the vertical position of the gauge wheels 32 (e.g., by blocking rotation of the arms in the upward direction beyond a selected orientation), thereby controlling the penetration depth of the opener discs 36 into the soil. In certain embodiments, the depth control system may include an actuator configured to control the vertical position of the gauge wheels. While the opener assembly 30 includes opener discs 36 in the illustrated embodiment, in other embodiments, the opener assembly may include any other suitable opener(s) (e.g., a single opener disc, knife blade opener(s), coulter(s), etc.) configured to form the trench in the soil.

The row unit 12 also includes an agricultural product conveying system (e.g., seed tube or powered agricultural product conveyor) configured to deposit agricultural product (e.g., seed, fertilizer, etc.) into the trench. The opener assembly 30 and the agricultural product conveying system are followed by a closing assembly 40 that moves displaced soil back into the trench. In the illustrated embodiment, the closing assembly 40 includes two closing discs 42. However, in other embodiments, the closing assembly may include other suitable closing device(s) (e.g., a single closing disc, etc.). In addition, in certain embodiments, the closing assembly may be omitted. In the illustrated embodiment, the closing assembly 40 is followed by a packing assembly 44 configured to pack soil on top of the deposited agricultural product. The packing assembly 44 includes a packer wheel 46, an arm 48 that pivotally couples the packer wheel 46 to the frame 24, and a biasing member 50 configured to urge the packer wheel 46 toward the soil surface 26, thereby enabling the packer wheel to pack soil on top of the deposited agricultural product. While the illustrated biasing member 50 includes a spring, in other embodiments, the biasing member may include other suitable biasing device(s) (e.g., alone or in combination with the spring), such as another spring, a hydraulic cylinder, a pneumatic cylinder, other suitable biasing device(s), or a combination thereof. Furthermore, in certain embodiments, the packing assembly may be omitted.

The row unit 12 includes a vacuum agricultural product meter 52 configured to receive agricultural product (e.g., seed, fertilizer, etc.) from a storage compartment 54. In the illustrated embodiment, the storage compartment 54 includes a mini-hopper configured to receive agricultural product (e.g., continuously, periodically, on-demand, etc.) from a central storage compartment of the agricultural implement during planting operations. However, in other embodiments, the storage compartment may include a hopper configured to store a sufficient amount of agricultural product to complete a desired planting operation, or any other suitable container or combination of containers. Furthermore, in the illustrated embodiment, the vacuum agricultural product meter 52 includes a disc having multiple openings. A vacuum is provided to one side of the disc (e.g., at a vacuum passage), thereby establishing an air pressure differential between opposite sides of the disc that induces the agricultural product (e.g., seed, etc.) to be captured within the openings. As the disc rotates, the agricultural product is conveyed toward the agricultural product conveying system. Once the agricultural product (e.g., seed, etc.) enters an outlet that extends to the agricultural product conveying system, the air pressure on each side of the disc is substantially equalized (e.g., at the end of the vacuum passage), thereby enabling the agricultural product (e.g., seed, etc.) to enter the agricultural product conveying system (e.g., agricultural product tube or powered agricultural product conveyor). The agricultural product conveying system then directs the agricultural product to the trench. As used herein, “vacuum” refers to an air pressure that is less than the ambient atmospheric air pressure, and not necessarily 0 pa. Furthermore, as used herein, “providing a vacuum” refers to establishing a vacuum within a volume (e.g., area, region, etc.) by removing air from the volume.

In the illustrated embodiment, the agricultural implement includes a pneumatic vacuum system 56 configured to provide the vacuum to the vacuum agricultural product meter 52. The pneumatic vacuum system 56 includes multiple pneumatic lines 58 configured to receive an airflow from an air source. The pneumatic vacuum system 56 also includes multiple pneumatic vacuum devices 60 (e.g., ejectors), and each pneumatic vacuum device 60 is fluidly coupled to a respective pneumatic line 58. Furthermore, each pneumatic vacuum device 60 is configured to receive the airflow from the respective pneumatic line 58 and to establish a respective vacuum based on the airflow. Each pneumatic vacuum device 60 is also configured to exhaust the airflow 62 to the atmosphere. In addition, each pneumatic vacuum device 60 is fluidly coupled to a respective vacuum agricultural product meter 52 to provide the respective vacuum to the respective vacuum agricultural product meter. While one pneumatic line 58 and one pneumatic vacuum device 60 are shown in FIG. 2, the pneumatic vacuum system 56 may include a respective pneumatic line 58 and a respective pneumatic vacuum device 60 for each vacuum agricultural product meter 52 of the agricultural implement.

In the illustrated embodiment, the pneumatic vacuum system 56 includes multiple vacuum hoses 64, and each vacuum hose 64 is fluidly coupled to a respective pneumatic vacuum device 60 and to a respective vacuum agricultural product meter 52. By fluidly coupling the pneumatic vacuum device 60 to the vacuum agricultural product meter 52, the vacuum hose 64 enables the pneumatic vacuum device 60 to provide the vacuum to the vacuum agricultural product meter 52. In certain embodiments, each pneumatic vacuum device 60 is positioned proximate to the respective vacuum agricultural product meter 52. As used herein with regard to the position of the pneumatic vacuum device 60 with respect to the vacuum agricultural product meter 52, “proximate” refers to a location closer to the vacuum agricultural product meter 52 than to the air source (e.g., within 10 cm of the vacuum agricultural product meter, within 20 cm of the vacuum agricultural product meter, within 30 cm of the vacuum agricultural product meter, within 50 cm of the vacuum agricultural product meter, etc.). Because each pneumatic vacuum device 60 is positioned proximate to the respective vacuum agricultural product meter 52, the length of each vacuum hose 64 may be reduced (e.g., as compared to vacuum hoses extending between a vacuum pump and the vacuum agricultural product meters), thereby reducing the cost of the agricultural implement. While each pneumatic vacuum device 60 is fluidly coupled to the respective vacuum agricultural product meter 52 by a respective vacuum hose 64 in the embodiment disclosed above, in certain embodiments, at least one pneumatic vacuum device may be directly fluidly coupled to the respective vacuum agricultural product meter, thereby obviating the respective vacuum hose. As a result, the cost of the agricultural implement may be further reduced.

In the illustrated embodiment, each vacuum hose 64 is substantially rigid. Accordingly, each pneumatic vacuum device 60 is fixedly coupled to the respective vacuum agricultural product meter 52 via the vacuum hose 64. As such, each vacuum agricultural product meter 52 supports the respective pneumatic vacuum device 60. In embodiments in which the pneumatic vacuum device is directly fluidly coupled to the respective vacuum agricultural product meter, the pneumatic vacuum device is also fixedly coupled to the respective vacuum agricultural product meter, thereby enabling the vacuum agricultural product meter to support the pneumatic vacuum device. Furthermore, in certain embodiments, at least one pneumatic vacuum device may be coupled to/supported by another suitable structure of the agricultural implement and fluidly coupled to the respective vacuum agricultural product meter via a rigid or flexible vacuum hose. For example, in certain embodiments, at least one pneumatic vacuum device may be coupled to the toolbar.

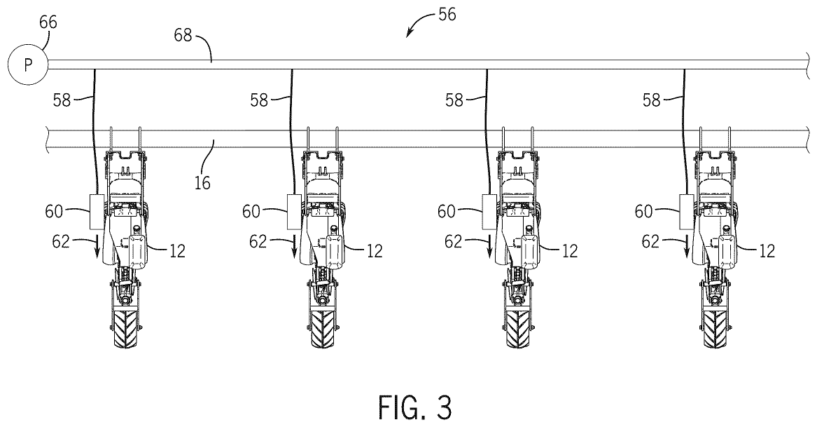

FIG. 3 is a top view of an embodiment of the pneumatic vacuum system 56 that may be employed within the agricultural implement of FIG. 1. In the illustrated embodiment, the pneumatic vacuum system 56 includes an air source 66 configured to output the airflow 62. The air source 66 may include any suitable device(s) configured to generate the airflow, such as fan(s), blower(s), turbine(s), compressor(s), etc., and each device may be driven (e.g., to rotate) by any suitable drive unit(s), such as electric motor(s), hydraulic motor(s), pneumatic motor(s), etc. In certain embodiments, the air source 66 may be configured to provide the airflow to other components/elements of the agricultural implement (e.g., to convey the agricultural product from the central storage compartment to the mini-hoppers, to inflate tires, etc.). Furthermore, in certain embodiments, the air source 66 may be configured to provide the airflow only to the pneumatic vacuum devices 60.

In the illustrated embodiment, the pneumatic vacuum system 56 includes a manifold 68 fluidly coupled to the air source 66 and to the pneumatic lines 58. The manifold 68 is configured to distribute the airflow from the air source 66 to the pneumatic lines 58. The manifold 68 may be substantially rigid, the manifold 68 may be flexible, or the manifold 68 may include one or more rigid sections and one or more flexible sections. In the illustrated embodiment, the manifold 68 extends along the toolbar 16, and the pneumatic lines 58 are distributed along the manifold 68. However, in other embodiments, the manifold may have any other suitable configuration. For example, in certain embodiments, the manifold may be positioned at the air source, and each pneumatic line may extend from the manifold to the respective pneumatic vacuum device. The pneumatic lines 58 may have any suitable length (e.g., based on the configuration and location of the manifold 68 and the positions of the pneumatic vacuum devices 60). For example, in certain embodiments, the manifold (e.g., flexible manifold) may extend to each of the pneumatic vacuum devices, and each pneumatic line may be a short connector (e.g., rigid or flexible) fluidly coupling the manifold to the respective pneumatic vacuum device. Furthermore, in certain embodiments, the manifold may be omitted, and the air source may be fluidly coupled to the pneumatic vacuum devices via the pneumatic lines. For example, in certain embodiments, the pneumatic lines and the pneumatic vacuum devices may be arranged in a serial configuration, in which the inlet of a first pneumatic line is fluidly coupled to the air source, and the inlet of each subsequent pneumatic line is fluidly coupled to the outlet of the previous pneumatic vacuum device.

As previously discussed, the pneumatic lines 58 are configured to receive the airflow 62 from the air source 66, and each pneumatic vacuum device 60 (e.g., ejector) is fluidly coupled to a respective pneumatic line 58. Furthermore, each pneumatic vacuum device 60 is configured to receive the airflow 62 from the respective pneumatic line 58 and to establish a respective vacuum based on the airflow 62. Each pneumatic vacuum device 60 is also configured to exhaust the airflow 62 to the atmosphere. In addition, each pneumatic vacuum device 60 is fluidly coupled to a respective vacuum agricultural meter to provide the respective vacuum to the respective vacuum agricultural product meter. Because the vacuum for each vacuum agricultural product meter is provided by the pneumatic vacuum system 56 based on the airflow 62 output by the air source 66, a vacuum pump is obviated. Accordingly, the noise generated by the agricultural implement may be reduced (e.g., because the air source may be quieter than a vacuum pump). Furthermore, the air source may utilize less energy to establish the vacuum within each vacuum agricultural product meter than the vacuum pump, thereby increasing the efficiency of the agricultural implement.

As discussed in detail above, in certain embodiments, the pneumatic vacuum system includes multiple vacuum hoses, and each vacuum hose is fluidly coupled to a respective pneumatic vacuum device and to a respective vacuum agricultural product meter. Furthermore, in certain embodiments, at least one pneumatic vacuum device (e.g., each pneumatic vacuum device) may be directly fluidly coupled to the respective vacuum agricultural product meter, thereby obviating the respective vacuum hose. Furthermore, in the illustrated embodiment, each pneumatic vacuum device 60 is positioned proximate to the respective vacuum agricultural product meter. However, in other embodiments, at least one pneumatic vacuum device 60 (e.g., each pneumatic vacuum device) may be positioned remote from the respective vacuum agricultural product meter. In addition, in the illustrated embodiment, each pneumatic vacuum device 60 is fixedly coupled to the respective vacuum agricultural product meter. However, in other embodiments, at least one pneumatic vacuum device may be coupled to/supported by another suitable structure of the agricultural implement. For example, in certain embodiments, at least one pneumatic vacuum device may be coupled to the toolbar. Furthermore, while each pneumatic vacuum device is fluidly coupled to a single vacuum agricultural product meter (e.g., directly or via a vacuum hose) in the embodiments disclosed above, in certain embodiments, at least one pneumatic vacuum device may be fluidly coupled to multiple vacuum agricultural product meters (e.g., on one row unit and/or on multiple row units), thereby providing the vacuum to multiple vacuum agricultural product meters.

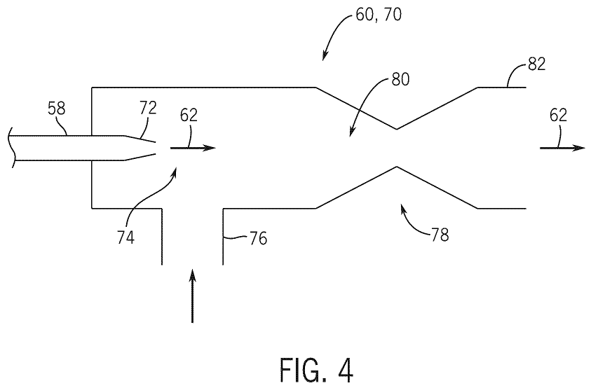

FIG. 4 is a schematic view of an embodiment of a pneumatic vacuum device 60 that may be employed within the pneumatic vacuum system of FIG. 3. As previously discussed, the pneumatic vacuum device 60 is fluidly coupled to a respective pneumatic line 58. In addition, the pneumatic vacuum device 60 is configured to receive the airflow 62 and to establish a respective vacuum based on the airflow 62. Furthermore, the pneumatic vacuum device 60 is configured to be fluidly coupled to a respective vacuum agricultural product meter to provide the vacuum to the respective vacuum agricultural product meter.

In the illustrated embodiment, the pneumatic vacuum device 60 includes an ejector 70 configured to use the Venturi effect to establish the vacuum. As illustrated, the ejector 70 includes a converging nozzle 72 fluidly coupled to the pneumatic line 58. The nozzle 72 is configured to direct the airflow 62 from the pneumatic line 58 into a first section 74 of the ejector 70. The ejector 70 includes an inlet 76 positioned at the first section 74, and the ejector is fluidly coupled to the respective vacuum agricultural product meter via the inlet 76. For example, the vacuum hose may extend from the inlet to the respective vacuum agricultural product meter. Within the first section 74, movement of the airflow 62 establishes a vacuum within the first section 74, thereby drawing air in through the inlet 76. As a result, the ejector 70 provides the vacuum to the respective agricultural product meter. While the ejector 70 includes a converging nozzle 72 in the illustrated embodiment, in other embodiments, the ejector may include a straight nozzle or a diverging nozzle. Furthermore, in certain embodiments, the nozzle may be omitted, and the pneumatic line may provide the airflow directly into the first region 74.

In the illustrated embodiment, the ejector 70 includes a diffuser 78, which establishes a second region 80 of the ejector 70. The diffuser 78 includes a converging section, which converges to a throat, and a diverging section, which diverges from the throat. The airflow 62 passes through the diffuser 78 and exits an outlet 82 of the ejector 70 to the atmosphere. While the ejector 70 includes the diffuser 78 in the illustrated embodiment, in certain embodiments, the diffuser may be omitted. Furthermore, in certain embodiments, the cross-sectional area (e.g., diameter) of the outlet 82 may be equal to the cross-sectional area (e.g., diameter) of the inlet 76. However, in other embodiments, the cross-sectional areas of the inlet and the outlet may be different than one another. Furthermore, in the illustrated embodiment, the cross-sectional area (e.g., diameter) of the outlet of the nozzle, or the pneumatic line in embodiments in which the nozzle is omitted, is less than the cross-sectional area (e.g., diameter) of the ejector inlet and the ejector outlet. However, in other embodiments, the cross-sectional area of the ejector inlet may be less than the cross-sectional area of the nozzle/pneumatic line outlet. In addition, while the pneumatic vacuum device 60 includes an ejector 70 in the illustrated embodiment, in other embodiments, the pneumatic vacuum device may include any other suitable device(s) configured to establish a vacuum based on an airflow.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112 (f).

1. A pneumatic vacuum system for an agricultural implement, comprising:
a plurality of pneumatic lines configured to receive an airflow from an air source; and
a plurality of pneumatic vacuum devices, wherein each pneumatic vacuum device of the plurality of pneumatic vacuum devices is fluidly coupled to a respective pneumatic line of the plurality of pneumatic lines, each pneumatic vacuum device of the plurality of pneumatic vacuum devices is configured to receive the airflow and to establish a respective vacuum based on the airflow, and each pneumatic vacuum device of the plurality of pneumatic vacuum devices is configured to be fluidly coupled to a respective vacuum agricultural product meter of the agricultural implement to provide the respective vacuum to the respective vacuum agricultural product meter.

2. The pneumatic vacuum system of claim 1, comprising a plurality of vacuum hoses, wherein each vacuum hose of the plurality of vacuum hoses is fluidly coupled to a respective pneumatic vacuum device of the plurality of pneumatic vacuum devices, and each vacuum hose of the plurality of vacuum hoses is configured to be fluidly coupled to a respective vacuum agricultural product meter of the agricultural implement.

3. The pneumatic vacuum system of claim 1, wherein each pneumatic vacuum device of the plurality of pneumatic vacuum devices is configured to be positioned proximate to the respective vacuum agricultural product meter.

4. The pneumatic vacuum system of claim 1, wherein each pneumatic vacuum device of the plurality of pneumatic vacuum devices comprises an ejector.

5. The pneumatic vacuum system of claim 1, comprising the air source configured to output the airflow.

6. The pneumatic vacuum system of claim 5, comprising a manifold fluidly coupled to the air source and to the plurality of pneumatic lines, wherein the manifold is configured to distribute the airflow from the air source to the plurality of pneumatic lines.

7. The pneumatic vacuum system of claim 1, wherein each pneumatic vacuum device of the plurality of pneumatic vacuum devices is configured to fixedly couple to the respective vacuum agricultural product meter.

8. A pneumatic vacuum system for an agricultural implement, comprising:
a first pneumatic line configured to receive an airflow from an air source;
a second pneumatic line configured to receive the airflow from the air source;
a first pneumatic vacuum device fluidly coupled to the first pneumatic line, wherein the first pneumatic vacuum device is configured to receive the airflow and to establish a first vacuum based on the airflow, and the first pneumatic vacuum device is configured to be fluidly coupled to a first vacuum agricultural product meter of the agricultural implement to provide the first vacuum to the first vacuum agricultural product meter; and
a second pneumatic vacuum device fluidly coupled to the second pneumatic line, wherein the second pneumatic vacuum device is configured to receive the airflow and to establish a second vacuum based on the airflow, and the second pneumatic vacuum device is configured to be fluidly coupled to a second vacuum agricultural product meter of the agricultural implement to provide the second vacuum to the second vacuum agricultural product meter.

9. The pneumatic vacuum system of claim 8, comprising:
a first vacuum hose fluidly coupled to the first pneumatic vacuum device, wherein the first vacuum hose is configured to be fluidly coupled to the first vacuum agricultural product meter; and
a second vacuum hose fluidly coupled to the second pneumatic vacuum device, wherein the second vacuum hose is configured to be fluidly coupled to the second vacuum agricultural product meter.

10. The pneumatic vacuum system of claim 8, wherein the first pneumatic vacuum device is configured to be positioned proximate to the first vacuum agricultural product meter, and the second pneumatic vacuum device is configured to be positioned proximate to the second vacuum agricultural product meter.

11. The pneumatic vacuum system of claim 8, wherein the first pneumatic vacuum device comprises a first ejector, and the second pneumatic vacuum device comprises a second ejector.

12. The pneumatic vacuum system of claim 8, comprising the air source configured to output the airflow.

13. The pneumatic vacuum system of claim 12, comprising a manifold fluidly coupled to the air source, to the first pneumatic line, and to the second pneumatic line, wherein the manifold is configured to distribute the airflow from the air source to the first pneumatic line and to the second pneumatic line.

14. The pneumatic vacuum system of claim 8, wherein the first pneumatic vacuum device is configured to fixedly couple to the first vacuum agricultural product meter, and the second pneumatic vacuum device is configured to fixedly couple to the second vacuum agricultural product meter.

15. An agricultural implement, comprising:
a toolbar,
a plurality of row units coupled to the toolbar, wherein each row unit of the plurality of row units comprises a respective vacuum agricultural product meter; and
a pneumatic vacuum system, comprising:
a plurality of pneumatic lines configured to receive an airflow from an air source; and
a plurality of pneumatic vacuum devices, wherein each pneumatic vacuum device of the plurality of pneumatic vacuum devices is fluidly coupled to a respective pneumatic line of the plurality of pneumatic lines, each pneumatic vacuum device of the plurality of pneumatic vacuum devices is configured to receive the airflow an to establish a respective vacuum based on the airflow, and each pneumatic vacuum device of the plurality of pneumatic vacuum devices is fluidly coupled to the vacuum agricultural product meter of a respective row unit of the plurality of row units to provide the respective vacuum to the vacuum agricultural product meter.

16. The agricultural implement of claim 15, wherein the pneumatic vacuum system comprises a plurality of vacuum hoses, and each vacuum hose of the plurality of vacuum hoses is fluidly coupled to a respective pneumatic vacuum device of the plurality of pneumatic vacuum devices and to the vacuum agricultural product meter of a respective row unit of the plurality of row units.

17. The agricultural implement of claim 15, wherein each pneumatic vacuum device of the plurality of pneumatic vacuum devices is positioned proximate to the vacuum agricultural product meter of the respective row unit.

18. The agricultural implement of claim 15, wherein the pneumatic vacuum system comprises the air source configured to output the airflow.

19. The agricultural implement of claim 18, wherein the pneumatic vacuum system comprises a manifold fluidly coupled to the air source and to the plurality of pneumatic lines, and the manifold is configured to distribute the airflow from the air source to the plurality of pneumatic lines.

20. The agricultural implement of claim 15, wherein each pneumatic vacuum device of the plurality of pneumatic vacuum devices is fixedly couple to the respective vacuum agricultural product meter.
